(19) United States
(12) Patent Application Publication
(10) Pub. No.: US 2007/0127044 A1
(43) Pub. Date: Jun. 7, 2007

(54) Print quality checking system and print quality checking method

(75) Inventor: Kozo Shimokawa, Hiroshima (JP)

Correspondence Address: NIXON PEABODY, LLP, 401 9TH STREET, NW, SUITE 900, WASHINGTON, DC, 20004-2128, US

(73) Assignee: RYOBI LTD.

(21) Appl. No.: 11/606,120

(22) Filed: Nov. 30, 2006

(30) Foreign Application Priority Data
Dec. 2, 2005 (JP) 2005-349855

(51) Int. Cl. H04N 1/60; G06K 9/00

(52) U.S. Cl. 358/1.9; 382/112

(57) ABSTRACT

In a print quality checking system and a print quality checking method for checking the print quality of a printed material by comparing read image data obtained by scanning the printed material with check criterion image data that is a criterion for checking print quality, in order to maintain the criterion fixed independently of printing conditions and printer conditions to provide a consistent, proper print quality check, printing plate data generated in consideration of characteristics of a printing unit and characteristics of a reader by a printing plate data generator in a process prior to printing or draft data is used as the check criterion image data. Unlike the case where a printed material is scanned by the reader to generate check criterion data, proper check criterion data having neither scratch nor stain is obtained without actually printing.

### CROSS-REFERENCE TO RELATED APPLICATION

This application claims priority under 35 USC 119 to Japanese Patent Application No. 2005-349855 filed on Dec. 2, 2005, the entire contents of which are incorporated herein by reference.

### BACKGROUND OF THE INVENTION

(a) Field of the Invention

This invention relates to print quality checking systems and methods for checking the print quality of printed materials.

(b) Description of the Related Art

In print quality checking systems of such kind, generally, a print operator visually inspects a number of materials printed in a preliminary printing process to previously select from among them an optimum printed material (hereinafter, also referred to as an OK sheet) that he or she determines that its print quality is OK. Then, in a print check process of an actual printing operation, printed materials are checked on the criterion of the OK sheet so that those deviating from the OK sheet are screened out as defectives.

In conventional preparation of an OK sheet, as for example disclosed in Published Japanese Patent Application No. 2004-195739 (particularly, in paragraph [0062] and FIG. 4), a print operator appropriately selects an OK sheet from printed materials.

Where a print operator selects an OK sheet from printed materials as disclosed above, however, its selection is made based on an independent judgment of the operator. Specifically, under the present circumstances, the judgment of whether proper printing has been performed is made independently of its original draft data and cannot help relying on the operator's skill.

Furthermore, according to the above manner of selecting a printed material as a criterion from a plurality of printed materials, the criterion may change with the printing conditions or conditions of the printer used, which makes it difficult to manage the print quality to maintain it consistent.

Particularly, in generating OK sheet data by scanning a printed material with a reader, the following problem might occur: If a printed material is scratched or stained owing to scanning using the reader, it generates improper OK sheet data, which may hinder proper printing.

Therefore, an object of the present invention is to maintain a fixed criterion for checking print quality independently of printing conditions and printer conditions to provide a consistent, proper print quality check.

### SUMMARY OF THE INVENTION

To attain the above object, the present invention uses printing plate preparation data used in preparing a printing plate for use in actual printing or uses prepress data used or generated in a process prior to printing (in prepress), such as print data (draft data) from which the generation of printing plate preparation data originates, to generate check criterion image data (OK sheet data) based on the printing plate preparation data or the prepress data.

Specifically, a first aspect of the present invention is directed to a print quality checking system comprising: a reader for scanning a material printed by a printing unit to obtain read image data; and a comparative checker for checking the print quality of the printed material by comparing the read image data obtained by the reader with check criterion image data that is a criterion for checking print quality.

Furthermore, the check criterion image data used in the comparative checker is configured based on image data generated in consideration of characteristics of the printing unit and characteristics of the reader in a process prior to printing.

With the above configuration in the first aspect of the present invention, check criterion image data is generated based on image data generated in a process prior to printing. Then, in a print quality check of the comparative checker, the check criterion image data is compared with read image data obtained by reading a printed material with the reader. Since thus the check criterion image data is generated based not on the printed material but on the image data obtained in the previous process, this provides proper check criterion data having neither scratch nor stain, unlike the case where check criterion image data is generated by reading a printed material with a reader. In addition, since the check criterion image data is obtained without actually printing, the check criterion for print quality can be fixed independently of printing conditions and printer conditions, which enables a consistent print quality check.

Furthermore, the check criterion image data is generated in consideration of characteristics of the printing unit and characteristics of the reader. Therefore, proper check criterion data can be generated by predicting, in consideration of the characteristics of the printing unit and the characteristics of the reader, image data that will be obtained by scanning the printed material with the reader in a print check process. This enhances the accuracy of the print quality check.

In a second aspect of the present invention, the comparative checker is configured to check the print quality of the printed material by comparing the read image data with the check criterion image data in consideration of the characteristics of the printing unit and the characteristics of the reader.

Thus, in checking the print quality of a printed material by comparing the check criterion image data with the read image data obtained by reading the printed material, the characteristics of the printing unit and the characteristics of the reader are taken into consideration. Therefore, the accuracy of the print quality check can be enhanced.

In a third aspect of the present invention, the image data generated in the process prior to printing and the associated read image data read from the associated printed material are managed according to common print job command information, and the comparative checker selects, according to the print job command information, the data configured based on the image data generated in the process prior to printing and associated with the read image data as the check criterion image data.

With the above configuration in the third aspect, the image data generated in the process prior to printing and the associated read image data on the associated printed material are managed according to common print job command information and, according to the print job command information, the data based on the image data generated in the process prior to printing is selected as the check criterion image data for the printed material. Thus, the image data generated in the process prior to printing or the data configured based on the image data is stored in association with the corresponding print job command information and the actual printing operation is also carried out in association with the corresponding print job command information. Therefore, the check criterion image data for the printed material can be automatically selected and the print quality check for the printed material can also be automatically conducted.

In a fourth aspect of the present invention, the comparative checker checks for scratches and stains of the printed material. Thus, a proper printing having neither scratch nor stain can be realized.

A fifth aspect of the present invention is directed to a method for checking the print quality of a printed material by comparing read image data obtained by scanning the material printed by a printing unit with a reader with check criterion image data that is a criterion for checking print quality.

Furthermore, in the method, the check criterion image data is configured based on image data generated in consideration of characteristics of the printing unit and characteristics of the reader in a process prior to printing. Also in this aspect of the present invention, the same operation and effects as in the first aspect can be exhibited.

A sixth aspect of the present invention is directed to a method for checking the print quality of a printed material by comparing read image data obtained by scanning the material printed by a printing unit with a reader with check criterion image data that is a criterion for checking print quality.

Furthermore, in the method, the check criterion image data is configured based on image data generated in a process prior to printing. Moreover, the print quality of the printed material is checked by comparing the read image data with the check criterion image data in consideration of characteristics of the printing unit and characteristics of the reader. Also in this aspect of the present invention, the same operation and effects as in the second aspect can be exhibited.

### BRIEF DESCRIPTION OF THE DRAWINGS

FIG. 1 is a block diagram showing the configuration of a print quality checking system according to Embodiment 1 of the present invention.

FIG. 2 is a diagram corresponding to FIG. 1 in Embodiment 2 of the present invention.

FIG. 3 is a diagram corresponding to FIG. 1 in Embodiment 3 of the present invention.

### DESCRIPTION OF THE PREFERRED EMBODIMENTS

Hereinafter, preferred embodiments of the present invention will be described in detail with reference to the drawings. The following description of the preferred embodiments is merely illustrative in nature and is not intended to limit the scope, applications and use of the invention.

### Embodiment 1

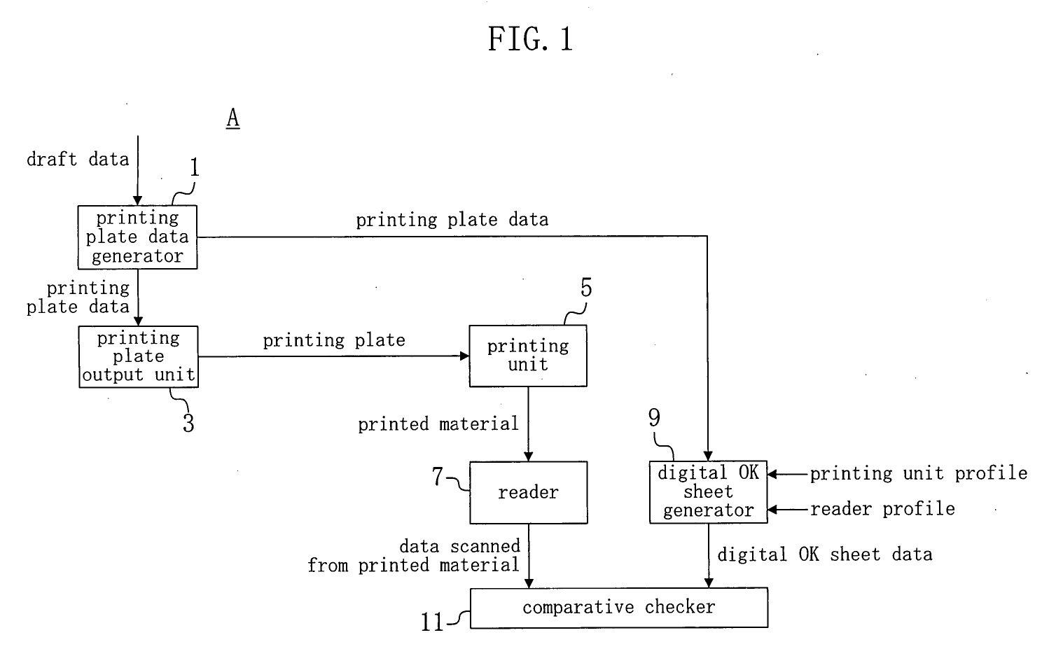

FIG. 1 shows a print quality checking system A according to Embodiment 1 of the present invention. The print quality checking system A is used as an inline checking system provided in a printer. The print quality checking system A includes a printing plate data generator 1, a printing plate output unit 3, a printing unit 5, a reader 7, a digital OK sheet generator 9 and a comparative checker 11.

The printing plate data generator 1 generates printing plate data for each type of print from draft data (for example, in a PDF format) based on print JOB information derived from an unshown management information system. The printing plate data generator 1 is composed of, for example, a raster image processor (RIP) for converting multi-valued data constituting the draft data to dotted binary data. The binary data is then converted, by software in the digital OK sheet generator 9, to multi-valued data having the same resolution as image data to be read by the reader 7. The RIP is hardware for rasterizing a page description language (PDL) described in mathematical formulae and etc. into a bit map (raster image). In preparing a printing plate, a software RIP is generally used for rasterizing a Post Script file by software.

The above-mentioned management information system is a system for properly providing necessary management information and is called MIS. The MIS issues print JOB information in a format such as a job definition format (JDF). The JDF is an industry-standard, electronic slip format made by CIP4 (The International Cooperation for the Integration of Process in Prepress, Press and Postpress) and adapted for human- and machine-readable prints. This format is used to provide computer-integrated manufacturing (CIM) in a factory, such as manpower-saving operation or automatic operation in a manufacturing process, through interactive data communication between manufacturing equipment and its management system, such as a MIS or a process management system. The JDF is described in XML.

The printing plate output unit 3 outputs a printing plate based on printing plate data generated by the printing plate data generator 1 and is composed of, for example, a CTP (Computer-To-Plate) engine. The CTP is a system that directly exposes a press plate material to light instead of outputting digital print data to a photographic paper or a film with an image setter and is also called “Direct to Plate”.

The printing unit 5 prints based on print JOB information issued from the management information system. In printing, the printing unit 5 calculates the amount of ink necessary for the printing plate sent from the printing plate output unit 3.

The reader 7 is an inline line scanner for scanning a material printed by the printing unit 5 to read it out as read image data and input it.

The digital OK sheet generator 9 generates, in a process prior to printing (in prepress), digital OK sheet data as check criterion data providing a check criterion for checking the print quality of printed materials. The digital OK sheet generator 9 inputs the printing plate data generated by the printing plate data generator 1 and also inputs printing characteristics of the printing unit 5 and reading characteristics of the reader (scanner) 7 as a printing unit profile and a reader profile, respectively. The digital OK sheet generator 9 uses, for each type of print, the associated printing plate data generated by the printing plate data generator 1 to predict image data that will be obtained by scanning a printed material of that type in consideration of the printing unit profile and the reader profile, generates digital OK sheet data from the prediction and stores it. The printing unit profile and the reader profile are generated so that the reader 7 scans and reads a material (sheet) previously printed by the printing unit 5 for the purpose of generating the profiles and respective characteristics of the printing unit 5 and the reader 7 are calculated from the reading results and collected as data. These profiles are disclosed in, for example, Published Japanese Patent Applications Nos. 2003-274205 and 2004-291278, and therefore the description thereof is not given here.

The comparative checker 11 is configured, after so that when in a printing process (in press) each material printed by the printing unit 5 is scanned and read out as read image data by the reader 7, it inputs the read image data, compares the read image data with the digital OK sheet data (check criterion image data) generated as a check criterion by the digital OK sheet generator 9 and checks the print quality of the printed material to determine whether the material is an OK printed material or an NG printed material. The NG printed material is a printed material deviated from the digital OK sheet in terms of concentration value or calorimetric value or a printed material having scratch and/or stain.

Though not shown, the printing unit is provided with two sheet output parts to which printed materials are ejected, one of the two sheet output parts is a non-defective output part and the other is a defective output part. Out of printed materials, those determined to be OK by the comparative checker 11 are ejected to the non-defective output part and those determined to be NG are ejected to the defective output part. Alternatively, the printing unit may be provided with a single sheet output part and configured to put a particular marking tape on each defective material using a tape inserter or apply inkjet marking to it, which are known techniques.

Next, a description is given of the operation of the above embodiment (i.e., an embodiment of a print quality checking method of the present invention). First, in a process prior to printing (in prepress), the digital OK sheet generator 9 generates digital OK sheet data for each type of print based on printing plate data generated by the printing plate data generator 1 and stores it.

In the generation of the digital OK sheet data, image data for each type of print that will be obtained after the reader (scanner) 7 scans a printed material for that type is predicted considering the characteristics of the printing unit 5 and the characteristics of the reader 7 as a printing unit profile and a reader profile, respectively.

Thereafter, in a printing process, the printing unit 5 prints materials for that type and the reader 7 scans each printed material and inputs the read image data. Then, the comparative checker 11 compares the read image data with the digital OK sheet data generated and stored in the digital OK sheet generator 9 to check the printed material in terms of quality, more specifically, the deviation of the printed material in concentration value and calorimetric value from their specified ranges and the presence or absence of scratch and stain. Then, if the printed material is determined to be OK by the comparative checker 11, it is ejected to the non-defective output part. On the other hand, if the printed material is determined to be NG by the comparative checker 11, it is screened out and ejected to the defective output part. The selection of appropriate digital OK sheet data from a data set stored in the digital OK sheet generator 9 is made by an operator.

According to this embodiment, when the comparative checker 11 compares the read image data obtained from the printed material by the scanning of the reader 7 with the OK sheet data as check criterion image data to check the print quality of the printed material, it uses as the OK sheet data the digital OK sheet data generated based on printing plate data in the process prior to printing (in prepress). Therefore, the check criterion for print quality can be fixed independently of printing conditions and printer conditions, which enables a consistent print quality check.

Furthermore, the digital OK sheet data is generated by predicting, in consideration of the characteristics of the printing unit 5 and the characteristics of the reader 7, image data that will be obtained by scanning the material printed by the printing unit 5 with the reader 7 in a print check process. Therefore, proper OK sheet data can be obtained corresponding to the characteristics of the printing unit 5 and the characteristics of the reader 7, which enhances the accuracy of the print quality check and thereby improves the print quality.

Furthermore, since the digital OK sheet data based on printing plate data in a process prior to printing (in prepress) is used as a check criterion, OK sheet data can be obtained without actually printing. Therefore, unlike the case where a printed material is preliminarily produced and read by the reader 7 to generate OK sheet data, it can be avoided that the OK sheet data contains scratches and stains involved in the reading. Hence, proper OK sheet data containing neither scratch nor stain can be obtained and printing causing neither scratch nor stain can be realized based on the OK sheet data.

### Embodiment 2

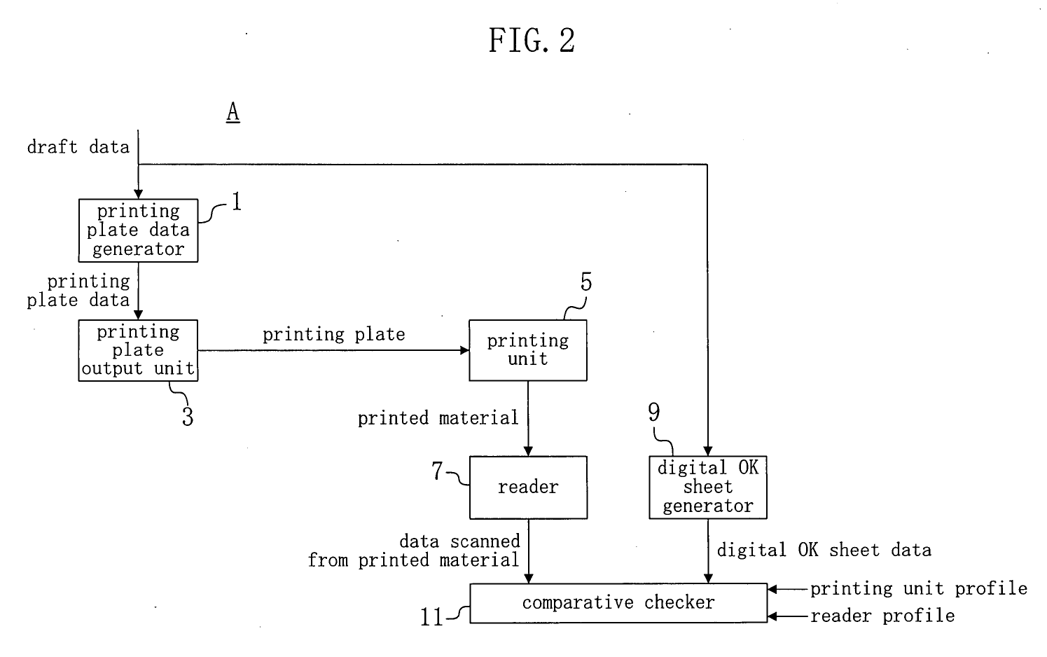

FIG. 2 shows a print quality checking system A according to Embodiment 2 of the present invention (note that in the following embodiments, the same parts as in FIG. 1 are identified by the same reference numerals and the detailed description thereof is not given). Though in Embodiment 1 digital OK sheet data is generated from printing plate data generated by the printing plate data generator 1, this embodiment is different from Embodiment 1 in that digital OK sheet data is generated from draft data to be input in the printing plate data generator 1.

Specifically, in this embodiment, draft data input into the printing plate data generator 1 is also input into the digital OK sheet generator 9 and the digital OK sheet generator 9 generates digital OK sheet data based on the draft data. The draft data is multi-valued data. Therefore, unlike Embodiment 1, there is not need to convert binary data to multi-valued data in the digital OK sheet generator 9.

Furthermore, unlike Embodiment 1 in which the characteristics of the printing unit 5 and the characteristics of the reader 7 are considered in generating digital OK sheet data in the digital OK sheet generator 9, the comparative checker 11 inputs the characteristic of the printing unit 5 and the characteristics of the reader 7 as a printing unit profile and a reader profile, respectively. In addition, the comparative checker 11 considers the characteristics of the printing unit 5 and the characteristics of the reader 7 when comparing input image data of the printed material scanned by the reader 7 with the digital OK sheet data as a check criterion generated by the digital OK sheet generator 9.

The other configurations are the same as in Embodiment 1. Therefore, this embodiment can exhibit the same operation and effects as in Embodiment 1.

### Embodiment 3

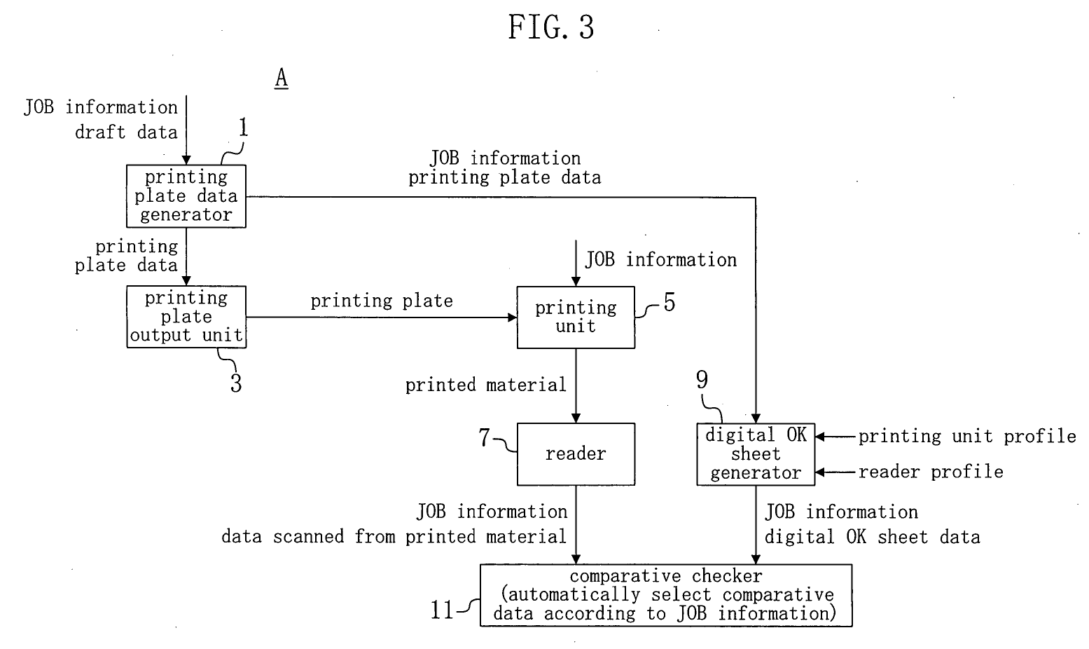

FIG. 3 shows a print quality checking system A according to Embodiment 3 of the present invention. In this embodiment, the comparative checker 11 automatically selects appropriate digital OK sheet data from a data set generated by the digital OK sheet generator 9, based on print JOB information derived from the management information system.

The print quality checking system A of this embodiment has the same configuration as that in Embodiment 1 (see FIG. 1) but print JOB information for the type of print in question is applied to each data in this system. Therefore, the printing plate generator 1 outputs not only printing plate data but also the print JOB information for the associated type of print to the digital OK sheet generator 9. Furthermore, the print JOB information is also input into the printing unit 5 and is also applied to the input image data scanned by the reader 7. Then, the comparative checker 11 automatically selects, from a plurality of digital OK sheets generated each for one type of print in the digital OK sheet generator 9, a particular digital OK sheet in image data form that should be used in the print quality check, based on the JOB information for the type of print in printing. Specifically, JOB identification information is applied to each data in this system and a JOB in printing and a JOB for the OK sheet can be identified according to the JOB identification information. The other configurations are the same as in Embodiment 1.

Therefore, this embodiment can also exhibit the same operation and effects as in Embodiment 1. In addition, since in this embodiment digital OK sheet data related to common JOB information with each type of print is automatically selected as one should be used in the comparative checker 11, this eliminates the need for the operator to select appropriate digital OK sheet data for each type of print, which makes the printing operation efficient. If JOB information contains data on printing conditions (such as the type of printing paper used and the type of ink used), a profile corresponding to such conditions can be automatically selected to generate a digital OK sheet.

### INDUSTRIAL APPLICABILITY

The present invention is very useful as a system and method for checking the print quality of a printed material by comparing read image data obtained by scanning the printed material with check criterion image data and, therefore, has a high industrial applicability.

What is claimed is:

1. A print quality checking system comprising:
a reader for scanning a material printed by a printing unit to obtain read image data; and
a comparative checker for checking the print quality of the printed material by comparing the read image data obtained by the reader with check criterion image data that is a criterion for checking print quality,
the check criterion image data used in the comparative checker being configured based on image data generated in consideration of characteristics of the printing unit and characteristics of the reader in a process prior to printing.

2. The print quality checking system of claim 1, wherein the comparative checker is configured to check the print quality of the printed material by comparing the read image data with the check criterion image data in consideration of the characteristics of the printing unit and the characteristics of the reader.

3. The print quality checking system of claim 1, wherein
the image data generated in the process prior to printing and the associated read image data read from the associated printed material are managed according to common print job command information, and
the comparative checker selects, according to the print job command information, the data configured based on the image data generated in the process prior to printing and associated with the read image data as the check criterion image data.

4. The print quality checking system of any one of claims 1 to 3, wherein the comparative checker checks for scratches and stains of the printed material.

5. A method for checking the print quality of a printed material by comparing read image data obtained by scanning the material printed by a printing unit with a reader with check criterion image data that is a criterion for checking print quality, said method comprising configuring the check criterion image data based on image data generated in consideration of characteristics of the printing unit and characteristics of the reader in a process prior to printing.

6. A method for checking the print quality of a printed material by comparing read image data obtained by scanning the material printed by a printing unit with a reader with check criterion image data that is a criterion for checking print quality, said method comprising:
configuring the check criterion image data based on image data generated in a process prior to printing; and
checking the print quality of the printed material by comparing the read image data with the check criterion image data in consideration of characteristics of the printing unit and characteristics of the reader.
